(19) United States
(12) Patent Application Publication
(10) Pub. No.: US 2023/0271416 A1
(43) Pub. Date: Aug. 31, 2023

(54) PRINT HEAD AND LIQUID EJECTING APPARATUS

(71) Applicant: SEIKO EPSON CORPORATION, Tokyo (JP)

(72) Inventor: Tatsuya SATO, Shiojiri (JP)

(21) Appl. No.: 18/173,105

(22) Filed: Feb. 23, 2023

(30) Foreign Application Priority Data
Feb. 25, 2022 (JP) 2022-028013

(51) Int. Cl. B41J 2/045; B41J 2/125

(52) U.S. Cl. CPC B41J 2/04555; B41J 2/04573; B41J 2/125

(57) ABSTRACT

A print head that includes a drive element to be driven when a drive signal is supplied to the drive element and that ejects liquid by the driving of the drive element includes an ejecting module including the drive element and a nozzle from which the liquid is ejected, and a current detecting circuit that detects a drive current generated due to propagation of the drive signal. The current detecting circuit includes a current detector that detects the drive current as a current detection signal, and a processor that controls an operation of the current detecting circuit according to the current detection signal.

The present application is based on, and claims priority from JP Application Serial Number 2022-028013, filed Feb. 25, 2022, the disclosure of which is hereby incorporated by reference herein in its entirety.

### BACKGROUND

### 1. Technical Field

The present disclosure relates to a print head and a liquid ejecting apparatus.

### 2. Related Art

As a liquid ejecting apparatus such as an ink jet printer that ejects ink as liquid to form an image and a document on a medium, a liquid ejecting apparatus that uses drive elements such as piezoelectric elements is known. In the liquid ejecting apparatus, each of the piezoelectric elements is provided corresponding to a respective one of a plurality of nozzles in an ejecting head that ejects liquid. Each of the piezoelectric elements is driven in accordance with a drive signal to eject a predetermined amount of liquid such as ink from a nozzle corresponding to the piezoelectric element at a predetermined timing. By performing this operation, the liquid ejecting apparatus ejects the liquid onto a medium to form a desired image or a desired character on the medium.

In such a liquid ejecting apparatus, it is important to manage a state of an ejecting head that ejects liquid onto a medium in order to improve the accuracy of ejecting liquid such as ink onto the medium. For example, JP-A-2021-053864 discloses a technique for managing a state of an ejecting head, such as the lifetime of the ejecting head, based on the number of times that the ejecting head ejects liquid such as ink and the number of times that a drive signal is supplied to a drive element.

However, the technique described in JP-A-2021-053864 is not sufficient to recognize and manage the state of the ejecting head in detail, and there is room for improvement.

### SUMMARY

According to an aspect of the present disclosure, a print head that includes a drive element to be driven when a drive signal is supplied to the drive element and that ejects liquid by the driving of the drive element includes an ejecting module including the drive element and a nozzle from which the liquid is ejected, and a current detecting circuit that detects a drive current generated due to propagation of the drive signal. The current detecting circuit includes a current detector that detects the drive current as a current detection signal, and a processor that controls an operation of the current detecting circuit according to the current detection signal.

According to another aspect of the present disclosure, a liquid ejecting apparatus includes a print head that includes a drive element to be driven when a drive signal is supplied to the drive element and that ejects liquid by the driving of the drive element, and a drive circuit that outputs the drive signal. The print head includes an ejecting module including the drive element and a nozzle from which the liquid is ejected, and a current detecting circuit that detects a drive current generated due to propagation of the drive signal. The current detecting circuit includes a current detector that detects the drive current as a current detection signal, and a processor that controls an operation of the current detecting circuit according to the current detection signal.

### BRIEF DESCRIPTION OF THE DRAWINGS

FIG. 1 is a diagram illustrating a schematic structure of a liquid ejecting apparatus.

FIG. 2 is a diagram illustrating a functional configuration of the liquid ejecting apparatus.

FIG. 3 is a diagram illustrating a schematic structure of an ejecting unit.

FIG. 4 is a diagram illustrating an example of a signal waveform of a drive signal.

FIG. 5 is a diagram illustrating a configuration of a drive signal selecting circuit.

FIG. 6 is a diagram illustrating an example of the content of decoding by a decoder.

FIG. 7 is a diagram illustrating a configuration of a selecting circuit corresponding to a single ejecting unit.

FIG. 8 is a diagram for explaining an operation of the drive signal selecting circuit.

FIG. 9 is a diagram illustrating an example of a configuration of a current detecting circuit.

FIG. 10 is a diagram for explaining a specific example of an operation of the current detecting circuit.

FIG. 11 is a diagram illustrating an example of a calculation operation of a CPU.

### DESCRIPTION OF EXEMPLARY EMBODIMENTS

Hereinafter, embodiments of the present disclosure are described with reference to the drawings. The drawings used are for convenience of explanation. The embodiments described below should not unduly limit the content of the present disclosure described in the claims. In addition, not all configurations described below are necessarily essential configurations of the present disclosure.

### 1. Structure of Liquid Ejecting Apparatus

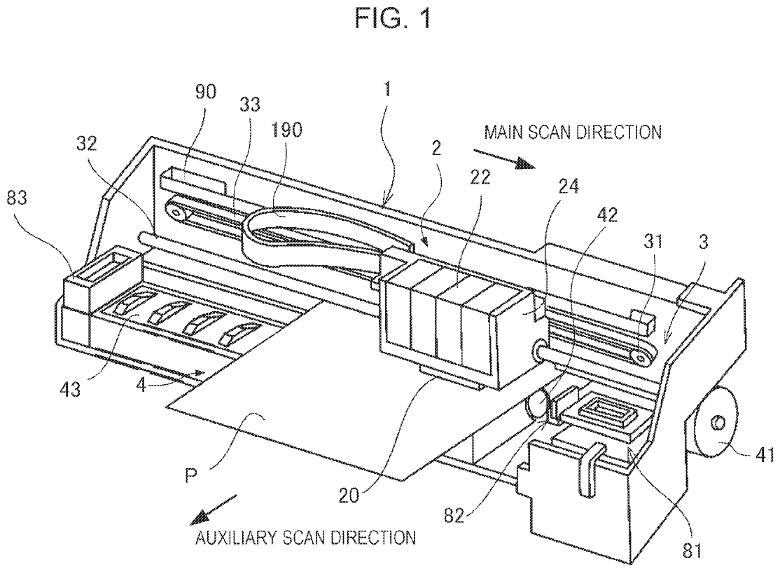

FIG. 1 is a diagram illustrating a schematic structure of a liquid ejecting apparatus 1 according to the present embodiment. The liquid ejecting apparatus 1 according to the embodiment is a so-called ink jet printer that ejects ink as an example of liquid according to image data supplied from a host computer provided outside the liquid ejecting apparatus 1 to form an image based on the image data on a medium P such as paper. The liquid ejecting apparatus 1 is not limited to an ink jet printer and may be a color material ejecting apparatus to be used to form a color filter for a liquid crystal display or the like, an electrode material ejecting apparatus to be used to form an electrode for an organic EL display, a surface emitting display, or the like, a bioorganic substance ejecting apparatus to be used to form a biochip, or the like.

As illustrated in FIG. 1, the liquid ejecting apparatus 1 includes a print head 2, a moving mechanism 3, and a transport mechanism 4. In FIG. 1, illustrations of some parts of the configuration, such as a housing, a cover, and the like of the liquid ejecting apparatus 1, are omitted.

The print head 2 includes an ejecting module 20 and a carriage 24. A predetermined number of ink cartridges 22 for storing ink to be ejected from the ejecting module 20 can be mounted on the carriage 24. The ejecting module 20 includes a plurality of nozzles described later and is attached to the carriage 24 such that the nozzles face the medium P. The print head 2 ejects a predetermined amount of ink from each of the nozzles at a timing defined by various control signals supplied through a cable 190 such as a flexible flat cable.

The moving mechanism 3 causes the carriage 24 included in the print head 2 to reciprocate in a main scan direction. The moving mechanism 3 includes a carriage motor 31, a carriage guide shaft 32, a timing belt 33, and a linear encoder 90. Both ends of the carriage guide shaft 32 are fixed to the housing of the liquid ejecting apparatus 1. The carriage guide shaft 32 supports the carriage 24 such that the carriage 24 can reciprocate. The timing belt 33 extends substantially parallel to the carriage guide shaft 32, and a part of the timing belt 33 is fixed to the carriage 24. The carriage motor 31 supplies drive force to the timing belt 33. Therefore, when the carriage motor 31 causes the timing belt 33 to move forward and backward, the carriage 24 fixed to the timing belt 33 is guided by the carriage guide shaft 32 such that the carriage 24 reciprocates in the main scan direction. That is, the moving mechanism 3 causes the print head 2 to reciprocate in the main scan direction.

In addition, the linear encoder 90 detects a scan position of the carriage 24 in the main scan direction and outputs information indicating the detected scan position as a detection signal. The liquid ejecting apparatus 1 controls output of the carriage motor 31 according to the information output from the linear encoder 90 and indicating the scan position of the carriage 24, thereby controlling the scan position of the print head 2 in the main scan direction.

The transport mechanism 4 transports the medium P in an auxiliary scan direction intersecting the main scan direction in which the carriage 24 reciprocates. The transport mechanism 4 includes a transport motor 41, a transport roller 42, and a platen 43. The transport motor 41 supplies drive force to the transport roller 42, thereby rotatably driving the transport roller 42. By rotatably driving the transport roller 42, the medium P is transported in the auxiliary scan direction. In this case, the medium P is supported on the platen 43. That is, the platen 43 guides the medium P transported by the transport roller 42 in the auxiliary scan direction.

As illustrated in FIG. 1, the liquid ejecting apparatus 1 includes a capping member 81, a wiper member 82, and a flushing box 83. The capping member 81 and the wiper member 82 are located at one end of a movement range of the carriage 24 in the main scan direction and at a home position serving as a base point for movement of the carriage 24. The capping member 81 seals a nozzle formation surface of the ejecting module 20. The wiper member 82 wipes the nozzle formation surface. The flushing box 83 is provided at the other end of the movement range of the carriage 24 on the platen 43 side in the main scan direction. The other end is located opposite to the home position from which the carriage 24 moves. The flushing box 83 collects ink ejected from the ejecting module 20 when a flushing operation is performed. The flushing operation is an operation of forcibly ejecting ink from each of the nozzles regardless of image data in order to eliminate the possibility that an inappropriate amount of ink may be ejected due to the clogging of the nozzles, air bubbles entering the nozzles, or the like due to the thickening of ink near the nozzles.

In the liquid ejecting apparatus 1 configured in the above-described manner, the medium P is transported in the auxiliary scan direction while being supported on the platen 43, and the carriage 24 reciprocates in the main scan direction in synchronization with the timing of transporting the medium P. In synchronization with the transport of the medium P and the movement of the carriage 24, ink is ejected from the ejecting module 20 attached to the carriage 24. Therefore, the ink can land at a desired position on the medium P, and as a result, a desired image can be formed on the medium P. In the following description, the auxiliary scan direction in which the medium P is transported may be referred to as a transport direction.

### 2. Functional Configuration of Liquid Ejecting Apparatus

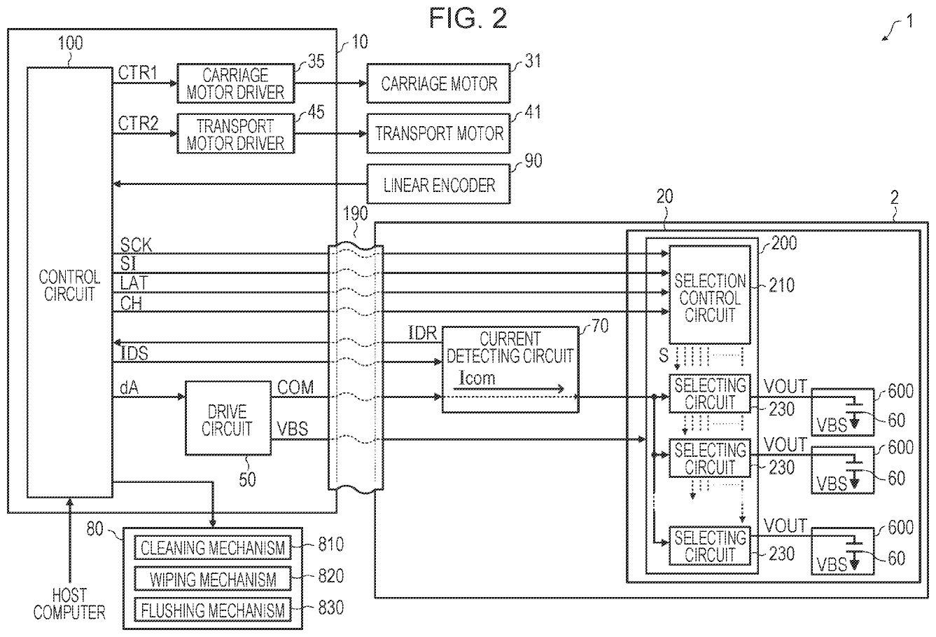

Next, a functional configuration of the liquid ejecting apparatus 1 is described. FIG. 2 is a diagram illustrating the functional configuration of the liquid ejecting apparatus 1. As illustrated in FIG. 2, the liquid ejecting apparatus 1 includes a print head control circuit 10 and the print head 2. The print head control circuit 10 is electrically coupled to the print head 2 via the cable 190.

The print head control circuit 10 includes a control circuit 100, a carriage motor driver 35, a transport motor driver 45, and a drive circuit 50.

Image data is supplied to the control circuit 100 from the host computer provided outside the liquid ejecting apparatus 1. The control circuit 100 generates various control signals according to the supplied image data and outputs the control signals to each configuration of the liquid ejecting apparatus 1.

Specifically, the control circuit 100 recognizes the current scan position of the print head 2 based on the detection signal output by the linear encoder 90. The control circuit 100 generates control signals CTR1 and CTR2 according to the scan position of the print head 2. The control signal CTR1 is supplied to the carriage motor driver 35. The carriage motor driver 35 drives the carriage motor 31 in accordance with the input control signal CTR1. In addition, the control signal CTR2 is supplied to the transport motor driver 45. The transport motor driver 45 drives the transport motor 41 in accordance with the input control signal CTR2. That is, the control circuit 100 controls the reciprocation of the print head 2 in the main scan direction and the transport of the medium P in the auxiliary scan direction.

In addition, the control circuit 100 generates a clock signal SCK, a print data signal SI, a latch signal LAT, a change signal CH, and a current detection control signal IDS based on the image data supplied from the host computer and the detection signal output by the linear encoder 90 and outputs the clock signal SCK, the print data signal SI, the latch signal LAT, the change signal CH, and the current detection control signal IDS to the print head 2.

In addition, the control circuit 100 causes a maintenance unit 80 to perform a maintenance process of returning an ink ejection state of the ejecting module 20 to a normal state. The maintenance unit 80 includes a cleaning mechanism 810, a wiping mechanism 820, and a flushing mechanism 830. As the maintenance process, the cleaning mechanism 810 performs a pumping process of suctioning thickened ink, air bubbles, and the like remaining in the ejecting module 20 by a tube pump not illustrated. As the maintenance process, the wiping mechanism 820 performs a wiping process of wiping off foreign matter such as paper dust adhering near the nozzles of the ejecting module 20 by the wiper member 82. The flushing mechanism 830 performs a flushing operation of returning an ink ejection state of each ejecting unit 600 to a normal state.

In addition, the control circuit 100 outputs a base drive signal dA to the drive circuit 50. The drive circuit 50 converts the input base drive signal dA from a digital signal to an analog signal and amplifies the converted analog signal to generate a drive signal COM1. Then, the drive circuit 50 outputs the generated drive signal COM1 to the print head 2. Specifically, the drive circuit 50 generates the drive signal COM1 by modulating the analog signal obtained by converting the base drive signal dA, performing class D amplification on the analog signal, and demodulating the amplified analog signal and outputs the generated drive signal COM1 to the print head 2. As long as the base drive signal dA defines a waveform of the drive signal COM1, the base drive signal dA may be an analog signal. As long as the drive circuit 50 amplifies the waveform defined by the base drive signal dA, the drive circuit 50 may be a class A amplifier circuit, a class B amplifier circuit, or a class AB amplifier circuit.

The drive circuit 50 generates a reference voltage signal VBS having a fixed voltage value of, for example, 5.5 V and supplies the reference voltage signal VBS together with the drive signal COM1 to the print head 2. The reference voltage signal VBS functions as a potential serving as a reference for driving piezoelectric elements 60 described later. The voltage value of the reference voltage signal VBS is not limited to 5.5 V, and the reference voltage signal VBS may have a fixed value of 6 V or 6.5 V or may have a fixed ground potential.

The print head 2 includes a current detecting circuit 70 and the ejecting module 20.

The drive signal COM1 and the current detection control signal IDS are input to the current detecting circuit 70. The drive signal COM1 propagates in the current detecting circuit 70 and is supplied as a drive signal COM2 to the ejecting module 20. In this case, the current detecting circuit 70 detects a drive current Icom generated when the drive signal COM1 propagates in the current detecting circuit 70. In addition, the current detecting circuit 70 estimates an operating state of the print head 2 including the ejecting module 20 based on the detected drive current Icom and the current detection control signal IDS input from the control circuit 100. Then, the current detecting circuit 70 generates a current detection result signal IDR according to the operating state of the print head 2 and outputs the current detection result signal IDR to the control circuit 100. The control circuit 100 corrects, based on the input current detection result signal IDR, various control signals for controlling each unit of the liquid ejecting apparatus 1, thereby controlling an operation of each configuration of the liquid ejecting apparatus 1 according to the operating state of the print head 2.

The ejecting module 20 includes a drive signal selecting circuit 200 and a number n of ejecting units 600. The drive signal selecting circuit 200 includes a selection control circuit 210 and a number n of selecting circuits 230 corresponding to the number n of ejecting units 600.

The clock signal SCK, the print data signal SI, the latch signal LAT, and the change signal CH are output by the control circuit 100 and input to the selection control circuit 210. Then, the selection control circuit 210 generates selection signals S each corresponding to a respective one of the number n of selecting circuits 230 and outputs the generated selection signals S to the corresponding selecting circuits 230.

The drive signal COM2 and the corresponding selection signals S are input to the number n of selecting circuits 230. Each of the selecting circuits 230 generates a drive signal VOUT by selecting or not selecting a signal waveform included in the drive signal COM2 based on the input selection signal S and outputs the generated drive signal VOUT to the ejecting unit 600 corresponding to the selecting circuit 230.

Each of the number n of ejecting units 600 includes a piezoelectric element 60. The drive signal VOUT output by the selecting circuit 230 corresponding to the ejecting unit 600 is supplied to one end of the piezoelectric element 60, and the reference voltage signal VBS is supplied to the other end of the piezoelectric element 60. Then, the piezoelectric element 60 is driven according to a potential difference between the drive signal VOUT supplied to the one end of the piezoelectric element 60 and the reference voltage signal VBS supplied to the other end of the piezoelectric element 60. Ink in an amount according to the driving of the piezoelectric element 60 is ejected from the ejecting unit 600 corresponding to the piezoelectric element 60.

As described above, the liquid ejecting apparatus 1 according to the embodiment includes the print head 2 that includes the piezoelectric elements 60 to be driven when the drive signals VOUT based on the drive signal COM1 are supplied to the piezoelectric elements 60 and that ejects liquid by the driving of the piezoelectric elements 60, and the drive circuit 50 that outputs the drive signal COM1. Since the drive signal COM1 propagates in the current detecting circuit 70 and the signal output from the current detecting circuit 70 is the drive signal COM2, the drive signal COM1 output by the drive circuit 50 is ideally the same as the drive signal COM2 output by the current detecting circuit 70. Therefore, in the following description, when it is not necessary to distinguish the drive signal COM1 and the drive signal COM, each of the drive signals COM1 and COM2 may be merely referred to as a drive signal COM.

### 3. Configuration and Operation of Print Head 2

Next, the configuration and operation of the print head 2 are described. As described above, the print head 2 includes the current detecting circuit 70 and the ejecting module 20.

### 3.1 Configuration and Operation of Ejecting Module 20

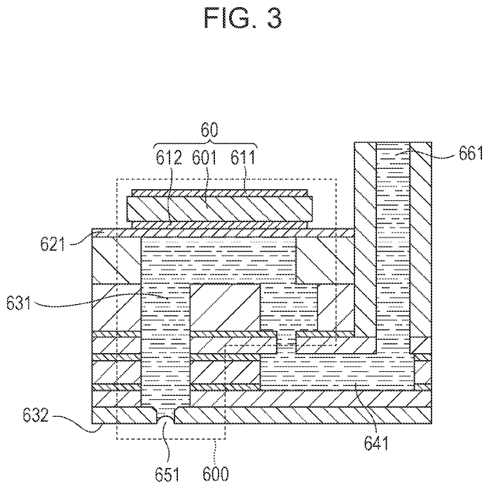

Before the configuration and operation of the ejecting module 20 are described, the structure of each of the ejecting units 600 included in the ejecting module 20 is described. FIG. 3 is a diagram illustrating a schematic structure of the ejecting unit 600. FIG. 3 illustrates the ejecting unit 600, a reservoir 641, and a supply port 661.

As illustrated in FIG. 3, the ejecting unit 600 includes the piezoelectric element 60, a vibration plate 621, a cavity 631, and a nozzle plate 632.

The piezoelectric element 60 includes a piezoelectric body 601 and electrodes 611 and 612. In the piezoelectric element 60, the electrodes 611 and 612 are located so as to sandwich the piezoelectric body 601. The piezoelectric element 60 configured in this manner is driven such that a central portion of the piezoelectric body 601 deforms in a vertical direction according to a potential difference between a voltage supplied to the electrode 611 and a voltage supplied to the electrode 612. In the piezoelectric element 60 according to the embodiment, the drive signal VOUT based on the drive signal COM is supplied to the electrode 611, and the reference voltage signal VBS having the fixed potential is supplied to the electrode 612. That is, the piezoelectric element 60 is driven such that the central portion of the piezoelectric body 601 deforms in the vertical direction due to a change in the voltage value of the drive signal VOUT supplied to the electrode 611.

In FIG. 3, the vibration plate 621 is located under the piezoelectric element 60. In other words, in FIG. 3, the piezoelectric element 60 is formed on an upper surface of the vibration plate 621. The vibration plate 621 deforms in the vertical direction due to the deformation of the piezoelectric element 60 due to the driving of the piezoelectric element 60.

In FIG. 3, the cavity 631 is located under the vibration plate 621. The cavity 631 communicates with the reservoir 641 commonly provided for the plurality of ejecting units 600. The reservoir 641 communicates with the supply port 661 through which the ink stored in the ink cartridge 22 is supplied to the reservoir 641. Therefore, the ink stored in the ink cartridge 22 is supplied into the cavity 631 through the supply port 661 and the reservoir 641. As a result, the inside of the cavity 631 is filled with the ink stored in the ink cartridge 22. The internal volume of the cavity 631 changes due to the deformation of the vibration plate 621 in the vertical direction. That is, the vibration plate 621 functions as a diaphragm that changes the internal volume of the cavity 631, while the cavity 631 functions as a pressure chamber in which pressure changes due to the deformation of the vibration plate 621.

A nozzle 651 is formed in the nozzle plate 632. That is, the ejecting unit 600 includes the piezoelectric element 60 and the nozzle 651 from which the ink is ejected. The nozzle 651 is an opening provided in the nozzle plate 632 and communicates with the cavity 631. The ink stored in the cavity 631 is ejected from the nozzle 651 according to a change in the internal volume of the cavity 631. A surface of the nozzle plate 632 in which the nozzle 651 is formed and that faces the medium P on which the ink lands corresponds to the nozzle formation surface described above.

In the ejecting unit 600 configured in the above-described manner, when the piezoelectric element 60 is driven so as to bend upward, the vibration plate 621 deforms upward. Therefore, the internal volume of the cavity 631 increases, and as a result, the ink stored in the reservoir 641 is drawn into the cavity 631. On the other hand, when the piezoelectric element 60 is driven so as to bend downward, the vibration plate 621 deforms downward. Therefore, the internal volume of the cavity 631 decreases, and as a result, the ink in an amount according to the amount of the decrease in the internal volume of the cavity 631 is ejected from the nozzle 651.

As long as the piezoelectric element 60 is driven so as to eject the ink from the nozzle 651 when the drive signal VOUT based on the drive signal COM is supplied to the piezoelectric element 60, the structure of the piezoelectric element 60 is not limited to the structure illustrated in FIG. 3.

Next, the configuration and operation of the drive signal selecting circuit 200 included in the ejecting module 20 are described. As described above, the drive signal selecting circuit 200 generates and outputs the drive signals VOUT by selecting or not selecting a signal waveform included in the drive signal COM based on the clock signal SCK, the print data signal SI, the latch signal LAT, and the change signal CH. Before the configuration and operation of the drive signal selecting circuit 200 are described, an example of the waveform of the drive signal COM input to the drive signal selecting circuit 200 is described below.

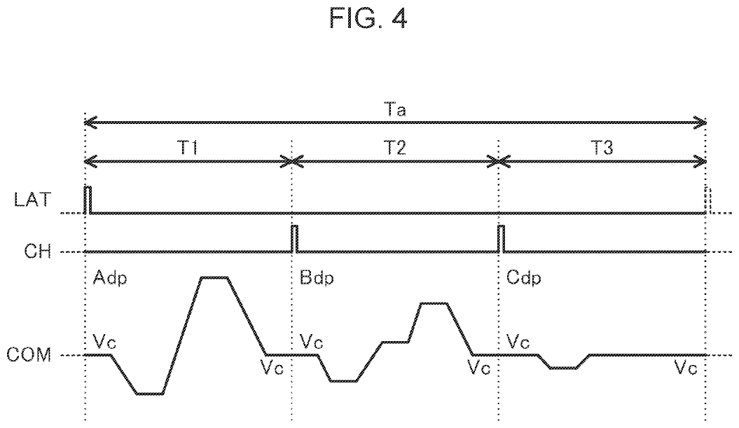

FIG. 4 is a diagram illustrating an example of the signal waveform of the drive signal COM. As illustrated in FIG. 4, the drive signal COM includes a trapezoidal waveform Adp in a time period T1 from a rising edge of the latch signal to a rising edge of the change signal CH, a trapezoidal waveform Bdp in a time period T2 from the rising edge of the change signal CH to a subsequent rising edge of the change signal CH, and a trapezoidal waveform Cdp in a time period T3 from the subsequent rising edge of the change signal CH to a subsequent rising edge of the latch signal LAT. The trapezoidal waveform Adp is a signal waveform that drives the piezoelectric element 60 so as to eject a predetermined amount of the ink from the ejecting unit 600 corresponding to the piezoelectric element 60 when the trapezoidal waveform Adp is supplied to the piezoelectric element 60. The trapezoidal waveform Bdp is a signal waveform that drives the piezoelectric element 60 so as to eject the ink in an amount smaller than the predetermined amount from the ejecting unit 600 corresponding to the piezoelectric element 60 when the trapezoidal waveform Bdp is supplied to the piezoelectric element 60. The trapezoidal waveform Cdp is a signal waveform that drives the piezoelectric element 60 so as not to eject the ink from the ejecting unit 600 corresponding to the piezoelectric element 60 when the trapezoidal waveform Cdp is supplied to the piezoelectric element 60. When the trapezoidal waveform Cdp is supplied to the piezoelectric element 60, the piezoelectric element 60 vibrates the ink present near the opening of the nozzle of the ejecting unit 600 corresponding to the piezoelectric element 60. This reduces the possibility that the viscosity of the ink present near the opening of the nozzle may increase.

Voltages of the trapezoidal waveforms Adp, Bdp, and Cdp at the start and end timings of the trapezoidal waveforms Adp, Bdp, and Cdp are a common voltage Vc. That is, each of the trapezoidal waveforms Adp, Bdp, and Cdp starts at the voltage Vc and ends at the voltage Vc.

In the following description, the predetermined amount of the ink ejected from the ejecting unit 600 corresponding to the piezoelectric element 60 when the trapezoidal waveform Adp is supplied to the piezoelectric element 60 may be referred to as a middle amount, and the amount of the ink ejected from the ejecting unit 600 corresponding to the piezoelectric element 60 when the trapezoidal waveform Bdp is supplied to the piezoelectric element 60 is smaller than the predetermined amount and may be referred to as a small amount. In addition, an operation of vibrating the ink present near the opening of the nozzle of the ejecting unit 600 corresponding to the piezoelectric element 60 to prevent an increase in the viscosity of the ink when the trapezoidal waveform Cdp is supplied to the piezoelectric element 60 may be referred to as slight vibration. The signal waveform of the drive signal COM illustrated in FIG. 4 is an example and is not limited thereto. A combination of various waveforms may be used for the drive signal COM according to properties of the ink to be ejected, the material of the medium P on which the ink lands, and the like.

The print head 2 according to the embodiment controls the amount of the ink to be ejected from each of the ejecting units 600 by causing the drive signal selecting circuit 200 to select or not to select each of the trapezoidal waveforms Adp, Bdp, and Cdp in a cycle Ta including the time periods T1, T2, and T3. That is, the size of a dot to be formed on the medium P in the cycle Ta is controlled. The cycle Ta including the time periods T1, T2, and T3 corresponds to a dot formation cycle in which a dot of a predetermined size is formed on the medium P.

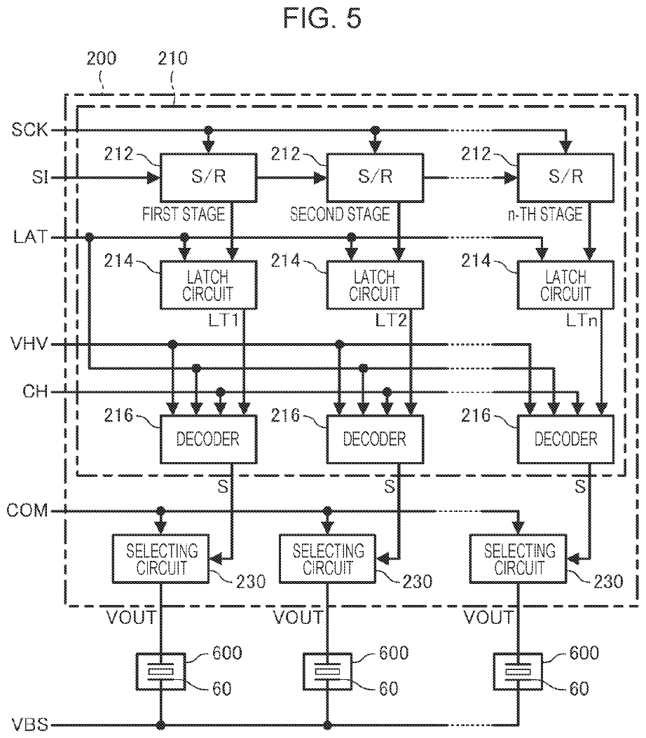

Next, the configuration and operation of the drive signal selecting circuit 200 that generates the drive signals VOUT by selecting or not selecting a signal waveform of the drive signal COM are described. FIG. 5 is a diagram illustrating the configuration of the drive signal selecting circuit 200. As illustrated in FIG. 5, the drive signal selecting circuit 200 includes the selection control circuit 210 and the number n of selecting circuits 230.

The clock signal SCK, the print data signal SI, the latch signal LAT, and the change signal CH are input to the selection control circuit 210. In the selection control circuit 210, a set of a shift register (S/R) 212, a latch circuit 214, and a decoder 216 is provided corresponding to each of the number n of ejecting units 600. That is, the drive signal selecting circuit 200 includes a number n of shift registers 212, a number n of latch circuits 214, and a number n of decoders 216.

The print data signal SI is input to the selection control circuit 210 in synchronization with the clock signal SCK. The print data signal SI serially includes 2-bit print data [SIH, SIL] corresponding to each of the number n of ejecting units 600 and provided for selecting any of a “large dot LD”, a “middle dot MD”, a “small dot SD”, and “non-recording ND”. That is, the print data signal SI is a 2-bit serial signal. The print data [SIH, SIL] included in the print data signal SI is held in the number n of shift registers 212 corresponding to the number n of ejecting units 600. Specifically, the number n of shift registers 212 corresponding to the ejecting units 600 are coupled to each other in a cascade arrangement, and the serially input print data signal SI is sequentially transferred to the subsequent shift registers 212 in accordance with the clock signal SCK. When the print data [SIH, SIL] is held in the corresponding shift registers 212, the clock signal SCK is stopped. In other words, when the supply of the clock signal SCK is stopped, the print data [SIH, SIL] included in the print data signal SI is held in the corresponding shift registers 212. In FIG. 5, in order to distinguish the number n of shift registers 212, the number n of shift registers 212 are denoted by the first stage, the second stage, . . . , and the n-th stage in order from the side on which the print data signal SI is input.

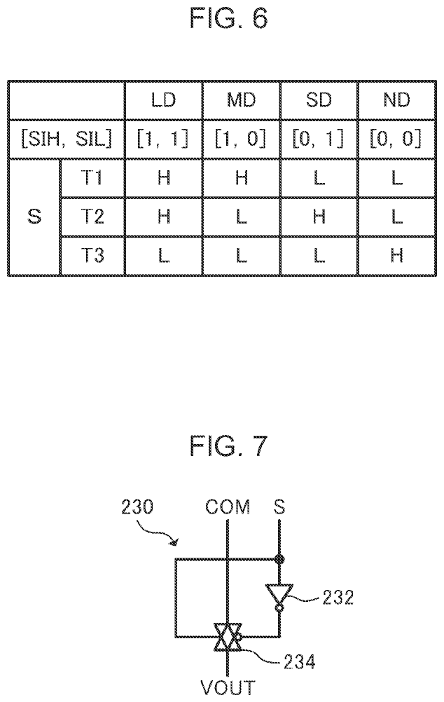

Each of the number n of latch circuits 214 collectively latches the print data [SIH, SIL] held in the shift register 212 corresponding to the latch circuit 214 at a rising edge of the latch signal LAT. Then, the print data [SIH, SIL] latched by each of the latch circuits 214 is input to the decoder 216 corresponding to the latch circuit 214. FIG. 6 is a diagram illustrating an example of the content of decoding by the decoder 216. The decoder 216 outputs a selection signal S of a logic level defined by the input print data [SIH, SIL] for each of the time periods T1, T2, and T3. For example, when print data [SIH, SIL]=[1, 0] is input to the decoder 216, the decoder 216 outputs a selection signal S with a logic level as an H level for the time period T1, an L level for the time period T2, and an L level for the time period T3.

The selection signals S output by the decoders 216 are input to the selecting circuits 230. The selecting circuits 230 are provided corresponding to the number n of ejecting units 600. That is, the drive signal selecting circuit 200 includes the same number n of selecting circuits 230 as the number n of ejecting units 600. FIG. 7 is a diagram illustrating a configuration of a selecting circuit 230 corresponding to a single ejecting unit 600. As illustrated in FIG. 7, each of the selecting circuits 230 includes an inverter 232 and a transfer gate 234. The inverter 232 is a NOT circuit.

A selection signal S is input to a positive control terminal of the transfer gate 234. The positive control terminal is not circled in FIG. 7. The selection signal S is also input to a negative control terminal of the transfer gate 234 after the logic level of the selection signal S is inverted by the inverter 232. The negative control terminal is circled in FIG. 7. In addition, the drive signal COM is supplied to an input terminal of the transfer gate 234. When the selection signal S is at a high level and input to the transfer gate 234, the transfer gate 234 causes the input terminal to be conductive with an output terminal of the transfer gate 234. When the selection signal S is at a low level and input to the transfer gate 234, the transfer gate 234 causes the input terminal to be non-conductive with the output terminal. That is, when the logic level of the selection signal S is a high level, the transfer gate 234 outputs a signal waveform included in the drive signal COM from the output terminal. When the logic level of the selection signal S is a low level, the transfer gate 234 does not output a signal waveform included in the drive signal COM from the output terminal.

The drive signal selecting circuit 200 outputs, as a drive signal VOUT, a signal from each of the output terminals of the transfer gates 234 included in the selecting circuits 230.

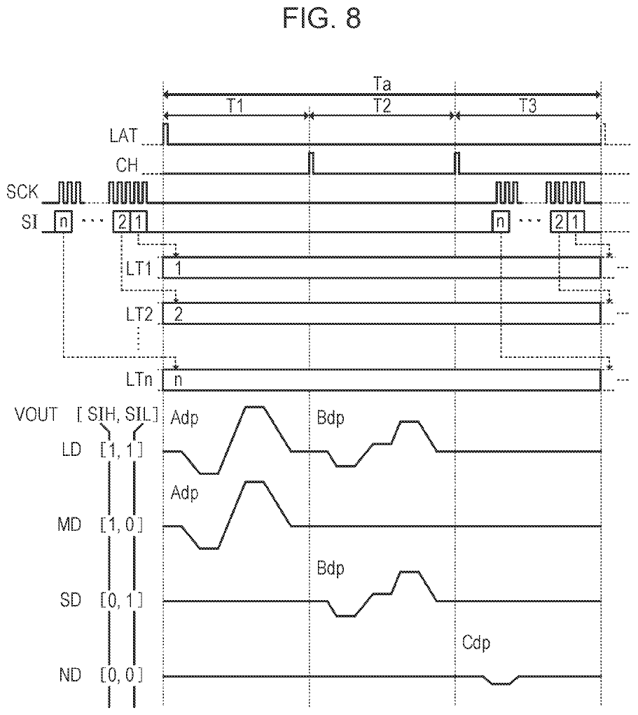

An operation of the drive signal selecting circuit 200 is described with reference to FIG. 8. FIG. 8 is a diagram for explaining the operation of the drive signal selecting circuit 200. The print data signal SI is input to the selection control circuit 210 as a serial signal synchronized with the clock signal SCK. Then, the print data signal SI is sequentially transferred to the number n of shift registers 212 corresponding to the number n of ejecting units 600 in synchronization with the clock SCK. Thereafter, when the input of the clock signal SCK is stopped, the print data [SIH, SIL] corresponding to each of the number n of ejecting units 600 is held in the shift registers 212. The print data signal SI is input in the order corresponding to the ejecting units 600 corresponding to the n-th stage, . . . , the second stage, and the first stage of the shift registers 212.

When the latch signal LAT rises, the latch circuits 214 collectively latch the print data [SIH, SIL] held in the shift registers 212. LT1, LT2, . . . , and LTn illustrated in FIG. 8 indicate the print data [SIH, SIL] latched by the latch circuits 214 corresponding to the shift registers 212 of the first stage, the second stage, . . . , and the n-th stage.

Each of the decoders 216 outputs a selection signal S of a logic level illustrated in FIG. 6 for each of the time periods T1, T2, and T3 according to a dot size defined by the latched print data [SIH, SIL]. Then, each of the selecting circuits 230 generates a drive signal VOUT by selecting or not selecting a signal waveform included in the drive signal COM according to the logic level of the selection signal S output by the decoder 216 corresponding to the selecting circuit 230.

Specifically, when print data [SIH, SIL]=[1, 1] is input to the decoder 216, the decoder 216 sets a logic level of a selection signal S to an H level for the time period T1, an H level for the time period T2, and an L level for the time period T3. Therefore, the selecting circuit 230 selects the trapezoidal waveform Adp in the time period T1, selects the trapezoidal waveform Bdp in the time period T1, and does not select the trapezoidal waveform Cdp in the time period T3. As a result, the drive signal selecting circuit 200 outputs a drive signal VOUT corresponding to the “large dot LD”.

When the drive signal VOUT corresponding to the “large dot LD” is supplied to the piezoelectric element 60 included in the ejecting unit 600, the ejecting unit 600 ejects the ink in the middle amount in the time period T1, ejects the ink in the small amount in the time period T2, and does not eject the ink in the time period T3. Then, the ink in the middle amount ejected from the ejecting unit 600 and the ink in the small amount ejected from the ejecting unit 600 land and are combined on the medium P to form the “large dot LD” on the medium P.

When print data [SIH, SIL]=[1, 0] is input to the decoder 216, the decoder 216 sets a logic level of a selection signal S to an H level for the time period T1, an L level for the time period T2, and an L level for the time period T3. Therefore, the selecting circuit 230 selects the trapezoidal waveform Adp in the time period T1, does not select the trapezoidal waveform Bdp in the time period T2, and does not select the trapezoidal waveform Cdp in the time period T3. As a result, the drive signal selecting circuit 200 outputs a drive signal VOUT corresponding to the “middle dot MD”.

When the drive signal VOUT corresponding to the “middle dot MD” is supplied to the piezoelectric element 60 included in the ejecting unit 600, the ejecting unit 600 ejects the ink in the middle amount in the time period T1, does not eject the ink in the time period T2, and does not eject the ink in the time period T3. Then, the ink in the middle amount ejected from the ejecting unit 600 lands on the medium P to form the “middle dot MD” on the medium P.

When print data [SIH, SIL]=[0, 1] is input to the decoder 216, the decoder 216 sets a logic level of a selection signal S to an L level for the time period T1, an H level for the time period T2, and an L level for the time period T3. Therefore, the selecting circuit 230 does not select the trapezoidal waveform Adp in the time period T1, selects the trapezoidal waveform Bdp in the time period T2, and does not select the trapezoidal waveform Cdp in the time period T3. As a result, the drive signal selecting circuit 200 outputs a drive signal VOUT corresponding to the “small dot SD”.

When the drive signal VOUT corresponding to the “small dot SD” is supplied to the piezoelectric element 60 included in the ejecting unit 600, the ejecting unit 600 does not eject the ink in the time period T1, ejects the ink in the small amount in the time period T2, and does not eject the ink in the time period T3. Then, the ink in the small amount ejected from the ejecting unit 600 lands on the medium P to form the “small dot SD” on the medium P.

When print data [SIH, SIL]=[0, 0] is input to the decoder 216, the decoder 216 sets a logic level of a selection signal S to an L level for the time period T1, an L level for the time period T2, and an H level for the time period T3. Therefore, the selecting circuit 230 does not select the trapezoidal waveform Adp in the time period T1, does not select the trapezoidal waveform Bdp in the time period T2, and selects the trapezoidal waveform Cdp in the time period T3. As a result, the drive signal selecting circuit 200 outputs a drive signal VOUT corresponding to the “non-recording ND”.

When the drive signal VOUT corresponding to the “non-recording ND” is supplied to the piezoelectric element 60 included in the ejecting unit 600, the ejecting unit 600 does not eject the ink in the time period T1, does not eject the ink in the time period T2, and does not eject the ink in the time period T3. Therefore, the ink is not ejected from the ejecting unit 600 and a dot is not formed on the medium P, resulting in the “non-recording ND”.

In this case, the corresponding selecting circuit 230 outputs a drive signal VOUT including the trapezoidal waveform Cdp. Therefore, the slight vibration is performed. As a result, the possibility that the viscosity of the ink present near the opening of the nozzle of the corresponding ejecting unit 600 may increase is reduced.

As described above, in the liquid ejecting apparatus 1 according to the embodiment, the ejecting module 20 includes the piezoelectric elements 60 to be driven when the drive signal COM is supplied to the piezoelectric elements 60, and the ejecting module 20 ejects the ink from the nozzles 651 by the driving of the piezoelectric elements 60. The ink is an example of liquid.

### 3.2 Configuration and Operation of Current Detecting Circuit

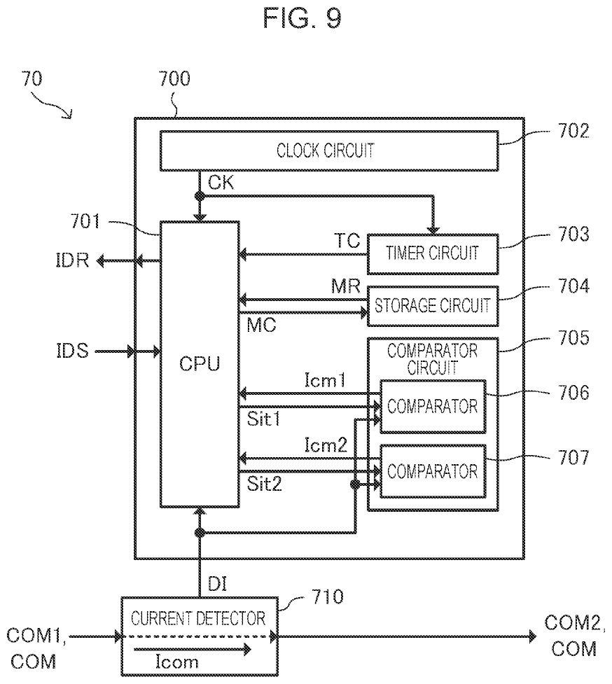

Next, the configuration and operation of the current detecting circuit 70 are described. FIG. 9 is a diagram illustrating an example of the configuration of the current detecting circuit 70. As illustrated in FIG. 9, the current detecting circuit 70 includes a semiconductor device 700 and a current detector 710.

The current detector 710 detects, as a current detection signal DI, a drive current Icom generated due to the propagation of the drive signal COM. The current detector 710 may include a shunt resistor and an operational amplifier that amplifies the voltage signal. In the current detector 710, it is possible to use a resistance detection type current detection method of converting a current to be detected into a voltage and calculating a value of the current to be detected from the value of the converted voltage, a magnetic field detection type current detection method of calculating a value of a current to be detected, based on a magnetic field generated due to the flow of the current to be detected, or the like. In addition, as the magnetic field detection type current detection method, it is possible to use various current detection methods, such as a magnetic field detection type current detection method in which a core material is provided around a wiring in which a current to be detected flows, and the value of the current to be detected is calculated by detecting a magnetic field generated in the core material due to the flow of the current to be detected in the wiring, a magnetic field detection type current detection method in which a core material is not used and a value of a current to be detected is calculated by detecting a magnetic field generated by drawing the current to be detected into a dedicated integrated circuit and causing the current to be detected to flow in the integrated circuit, and a magnetic field detection type current detection method in which a value of a current to be detected is calculated by using a magneto impedance (MI) element to detect a magnetic field generated due to the flow of the current to be detected without contact with the magnetic field.

The current detector 710 according to the embodiment detects the amount of the drive current Icom generated due to the propagation of the drive signal Com to drive the piezoelectric elements 60. Therefore, when a loss occurs due to the detection of the drive current Icom, the waveform of the drive signal COM may be distorted and ink ejection characteristics of the print head 2 may be degraded. Therefore, as a current detection method of detecting the amount of the drive current Icom generated due to the propagation of the drive signal Com in the liquid ejecting apparatus 1, a method in which a loss caused by the detection of the amount of the drive current Icom is small is preferable. In addition, since the current detecting circuit 70 according to the embodiment is included in the print head 2, a configuration in which the current detecting circuit 70 can be implemented in a small space is preferable in order to downsize the print head 2. When this point is taken into consideration, the current detector 710 detects the value of the drive current Icom without contact and thus a loss is small. In addition, since a single base part can detect the value of the drive current Icom, a magnetic detection type method in which an MI element that can be mounted in a small space is used is preferable.

The semiconductor device 700 includes a CPU 701, a clock circuit 702, a timer circuit 703, a storage circuit 704, and a comparator circuit 705. The current detection control signal IDS output by the control circuit 100 and the current detection signal DI output by the current detector 710 are input to the semiconductor device 700. Then, the semiconductor device 700 detects the state of the print head 2 based on the input current detection control signal IDS and the input current detection signal DI, generates a current detection result signal IDR according to the detected state of the print head 2, and outputs the generated current detection result signal IDR to the control circuit 100.

The clock circuit 702 generates a clock signal CK defining an operation timing of each of the units of the semiconductor device 700 and outputs the clock signal CK to the CPU 701 and the timer circuit 703. The clock circuit 702 may be a so-called internal clock circuit that is provided in the semiconductor device 700 as illustrated in FIG. 9 and generates the clock signal CK. Alternatively, the clock circuit 702 may be an external clock circuit provided outside the semiconductor device 700 and including an oscillator not illustrated. Alternatively, a part of the clock circuit 702 may be provided in the semiconductor device 700 and the other part of the clock circuit 702 may be provided outside the semiconductor device 700. The clock signal CK output by the clock circuit 702 may be supplied to each of the units of the semiconductor device 700 in addition to the CPU 701 and the timer circuit 703.

The clock signal CK is input to the timer circuit 703. The timer circuit 703 generates a timer signal TC of a predetermined cycle by dividing or multiplying the frequency of the input clock signal CK and outputs the generated timer signal TC to the CPU 701. That is, the current detecting circuit 70 includes the timer circuit 703.

The storage circuit 704 stores an operating state of the print head 2 based on a storage circuit control signal MC output by the CPU 701 and stores various types of information of the print head 2 according to the current detection signal DI detected by the current detector 710. In addition, the storage circuit 704 reads various types of information stored based on the storage circuit control signal MC output by the CPU 701 and outputs the read information as a read signal MR to the CPU 701. The information stored in the storage circuit 704 includes, for example, a cumulative value of the drive current Icom supplied to the ejecting module 20, a cumulative printing period for which the print head 2 performed a printing process, a cumulative driving period for which the print head 2 was driven, driving information according to the driving of the print head 2, determination information that is used for various determinations in the current detecting circuit 70, and the like. The storage circuit 704 may store execution information of the maintenance process by the maintenance unit 80 and the like in addition to the driving information and the determination information.

The comparator circuit 705 includes comparators 706 and 707.

A threshold information signal Sit1 output by the CPU 701 and the current detection signal DI output by the current detector 710 are input to the comparator 706. Next, the comparator 706 generates a comparison result signal Icm1 indicating a comparison result according to whether the value of the drive current Icom defined by the current detection signal DI is equal to or larger than a current threshold Ith1 defined by the threshold information signal Sit1. Then, the comparator 706 outputs the generated comparison result signal Icm1 to the CPU 701. In addition, a threshold information signal Sit2 output by the CPU 701 and the current detection signal DI output by the current detector 710 are input to the comparator 707. Next, the comparator 707 generates a comparison result signal Icm2 indicating a comparison result according to whether the value of the drive current Icom defined by the current detection signal DI is equal to or larger than a current threshold Ith2 defined by the threshold information signal Sit2. Then, the comparator 707 outputs the generated comparison result signal Icm2 to the CPU 701.

In the following description, it is assumed that when the value of the drive current Icom defined by the input current detection signal DI is equal to or larger than the current threshold Ith1, the comparator 706 according to the embodiment outputs the comparison result signal Icm1 at an H level, and that when the value of the drive current Icom defined by the input current detection signal DI is equal to or larger than the current threshold Ith2, the comparator 707 outputs the comparison result signal Icm2 at an H level. As each of the comparators 706 and 707, for example, a comparison calculator can be used.

The CPU 701 controls each configuration of the semiconductor device 700 including the storage circuit 704 and the comparator circuit 705 based on the current detection control signal IDS input from the control circuit 100 and the current detection signal DI output by the current detector 710 and determines a driving state of the print head 2 based on the current detection signal DI output by the current detector 710, the timer signal TC output by the timer circuit 703, the read signal MR read from the storage circuit 704, and the comparison result signals Icm1 and Icm2 output by the comparators 706 and 707. In addition, the CPU 701 generates a current detection result signal IDR according to the determined driving state of the print head 2, outputs the generated current detection result signal IDR to the control circuit 100, generates a storage circuit control signal MC including information according to the determined driving state of the print head 2, and outputs the generated storage circuit control signal MC to the storage circuit 704. Therefore, the information according to the driving state of the print head 2 is stored in the storage circuit 704. That is, the CPU 701 controls the operation of the current detecting circuit 70 based on the current detection signal DI according to the drive current Icom. The CPU 701 may include an A/D converter or a D/A converter that converts the input various signals into digital signals or analog signals.

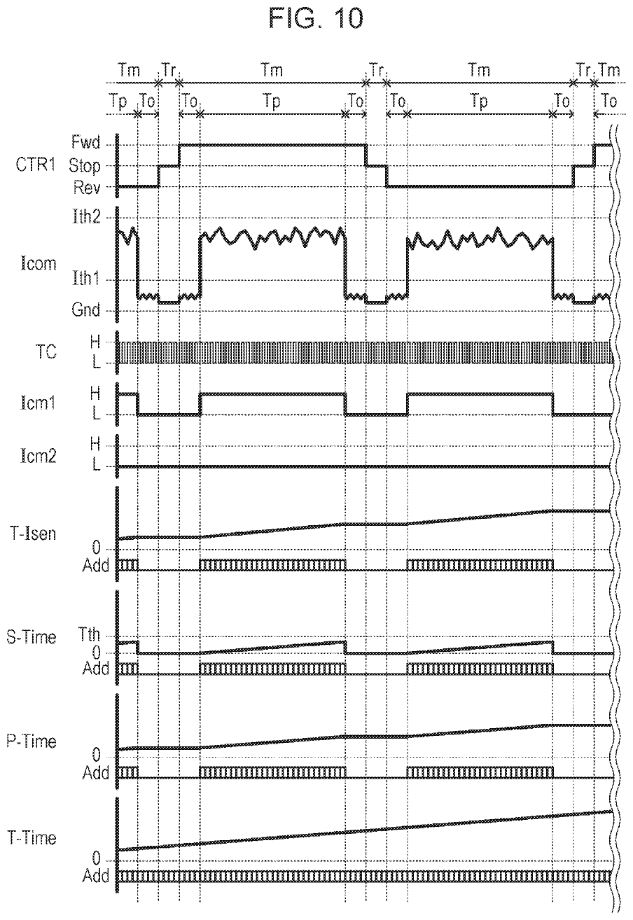

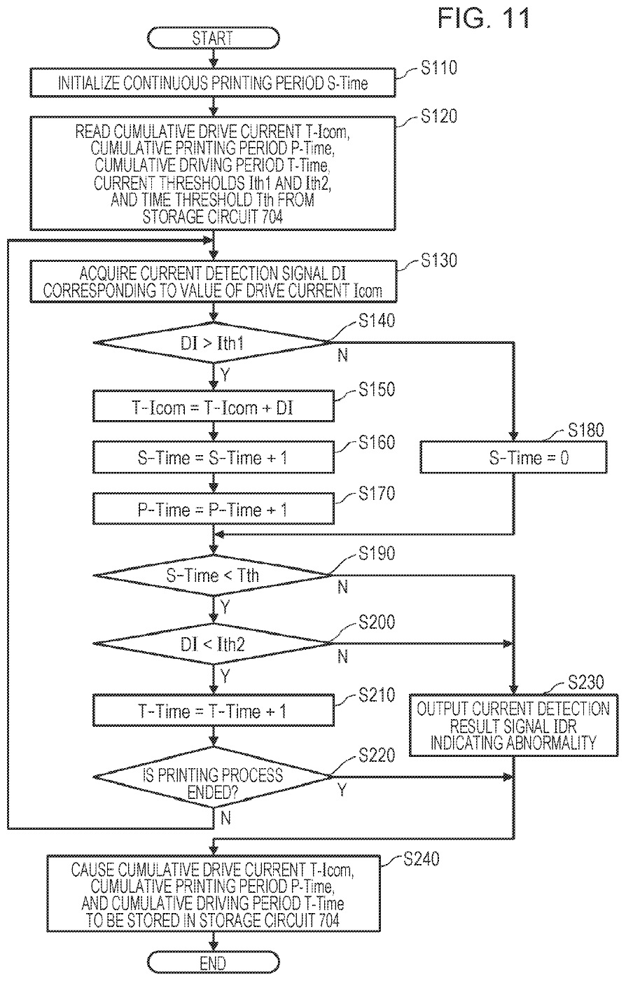

A specific example of the operation of the current detecting circuit 70 configured in the above-described manner is described below. FIG. 10 is a diagram for explaining the specific example of the operation of the current detecting circuit 70. FIG. 10 illustrates a control signal CTR1 to control a movement of the print head 2 in the main scan direction, in addition to various signals in the current detecting circuit 70. A forward direction control signal Fwd as the control signal CTR1 illustrated in FIG. 10 is a signal to move the print head 2 from one side to the other side in the main scan direction, a backward direction control signal Rev as the control signal CTR1 is a signal to move the print head 2 from the other side to the one side in the main scan direction, and a stop control signal Stop as the control signal CTR1 is a signal to stop the print head 2. In the following description, a direction toward which the print head 2 is moved when the control circuit 100 outputs the forward direction control signal Fwd as the control signal CTR1 may be referred to as a forward direction, while a direction toward which the print head 2 is moved when the control circuit 100 outputs the backward direction control signal Rev as the control signal CTR1 may be referred to as a backward direction.

As illustrated in FIG. 10, an image formation period in which the liquid ejecting apparatus 1 ejects the ink to the medium P so as to form a desired image on the medium P includes a movement direction switching period Tr and a main scan direction movement period Tm.

The movement direction switching period Tr is a time period in which the control circuit 100 outputs the stop control signal Stop as the control signal CTRL and corresponds to a time period for which the print head 2 is stopped. In the movement direction switching period Tr, the movement direction of the print head 2 is switched from the forward direction to the backward direction or from the backward direction to the forward direction. In addition, for the movement direction switching period Tr, the selecting circuits 230 included in the drive signal selecting circuit 200 are controlled to be non-conductive. Therefore, drive signals VOUT based on the drive signal Com are not supplied to the piezoelectric elements 60. As a result, for the movement direction switching period Tr, the value of the drive current Icom generated due to the propagation of the drive signal COM in the current detecting circuit 70 is very low. In the movement direction switching period Tr, the drive circuit 50 may output a voltage signal with a fixed voltage Vc as the drive signal COM.

The main scan direction movement period Tm is a time period in which the carriage 24 included in the print head 2 reciprocates in the main scan direction. The main scan direction movement period Tm includes a non-printing period To for which the ink is not ejected to the medium P, and a printing period Tp in which the ink is ejected to the medium P.

The non-printing period To is a time period for which the print head 2 does not eject the ink to the medium P and for which the slight vibration is performed. That is, in the non-printing period To, drive signals VOUT corresponding to the non-recording ND illustrated in FIG. 8 are supplied to the piezoelectric elements 60. In this case, the piezoelectric elements 60 slightly deform such that the ink is not ejected from the corresponding nozzles 651. That is, for the non-printing period To, amounts of currents generated due to the drive signal Com and supplied to the piezoelectric elements 60 are small. Therefore, for the non-printing period To, the value of the drive current Icom generated due to the propagation of the drive signal COM in the current detecting circuit 70 is low, similarly to the value of the drive current Icom generated due to the propagation of the drive signal COM in the current detecting circuit 70 for the movement direction switching period Tr.

The printing period Tp is a time period in which the print head 2 ejects the ink to the medium P. That is, in the printing period Tp, a drive signal VOUT illustrated in FIG. 8 according to an amount of the ink to be ejected from a nozzle 651 corresponding to at least one of the piezoelectric elements 60 is supplied to the piezoelectric element 60. In this case, the piezoelectric element 60 largely deforms such that the ink is ejected from the corresponding nozzle 651. Therefore, the amount of a current generated due to the drive signal COM to be supplied to the piezoelectric element 60 in the printing period Tp is sufficiently larger than the amount of a current generated due to the drive signal COM when a drive signal VOUT corresponding to the non-recording ND is to be supplied to the piezoelectric element 60. Therefore, the value of the drive current Icom generated due to the propagation of the drive signal Com in the current detecting circuit 70 in the printing period Tp is sufficiently higher than the value of the drive current Icom generated due to the propagation of the drive signal COM in the current detecting circuit 70 in each of the movement direction switching period Tr and the non-printing period To.

The non-printing period To includes a time period that is included in the main scan direction movement period Tm and for which the medium P is located so as not to face the nozzle formation surface in which the nozzles 651 included in the print head 2 are formed. The printing period Tp includes a time period that is included in the main scan direction movement period Tm and for which a print region of the medium P is located facing the nozzle formation surface in which the nozzles 651 included in the print head 2 are formed. In the following description, a region in which the print head 2 is located in the non-printing period To may be referred to as a non-printing region, and a region in which the print head 2 is located in the printing period Tp may be referred to as a printing region.

As described above, the comparator 706 outputs the comparison result signal Icm1 at an H level when the value of the drive current Icom defined by the input current detection signal DI is equal to or larger than the current threshold Ith1 defined by the threshold information signal Sit1. The CPU 701 generates the threshold information signal Sit1 including the current threshold Ith1 that is smaller than the current detection signal D1 corresponding to the value of the drive current Icom generated due to the propagation of the drive signal COM in the current detecting circuit 70 in the printing period Tp and is larger than the current detection signal D1 corresponding to the value of the drive current Icom generated due to the propagation of the drive signal COM in the current detecting circuit 70 in each of the movement direction switching period Tr and the non-printing period To. Then, the CPU 701 outputs the generated threshold information signal Sit1 to the comparator 706. Therefore, the comparator 706 outputs the comparison result signal Icm1 at an H level to the CPU 701 for the printing time period Tp in the image formation period in which the liquid ejecting apparatus 1 ejects the ink to the medium P to form a desired image on the medium P. The comparator 706 outputs the comparison result signal Icm1 at an L level to the CPU 701 for the movement direction switching period Tr and the non-printing period To in the image formation period.

That is, the comparator 706 outputs the comparison result signal Icm1 at an H level for a time period in which the print head 2 ejects the ink to the medium P. The comparator 706 outputs the comparison result signal Icm1 at an L level to the CPU 701 for a time period for which the print head 2 does not eject the ink to the medium P. Therefore, the CPU 701 determines the operating state of the print head 2 based on the logic level of the comparison result signal Icm1 input from the comparator 706.

That is, the comparator 706 compares the current detection signal D1 corresponding to the drive current Icom with the current threshold Ith1 defined by the threshold information signal Sit1, and the CPU 701 determines the operating state of the print head 2 according to the comparison result signal Icm1 output by the comparator 706. In this case, the current threshold Ith1 input to the comparator 706 may be changeable based on the threshold information signal Sit1 output by the CPU 701. Therefore, even when the amount of a current generated based on the drive signal COM changes according to the type of the ink to be ejected to the medium P or the number of nozzles included in the ejecting module 20, the CPU 701 can accurately determine the operating state of the printing head 2 according to the comparison result signal Icm1 output by the comparator 706.

The comparator 707 outputs the comparison result signal Icm2 at an H level when the value of the drive current Icom defined by the current detection signal D1 input as described above is equal to or larger than the current threshold Ith2 defined by the threshold information signal Sit2. In this case, the current threshold Ith2 defined by the threshold information signal Sit2 input to the comparator 707 is set to a value sufficiently larger than the current detection signal D1 corresponding to the value of the drive current Icom generated due to the propagation of the drive signal COM in the current detecting circuit 70 in the printing period Tp. That is, the current threshold Ith2 defined by the threshold information signal Sit2 is larger than the current threshold Ith1 defined by the threshold information signal Sit1.

The comparator 707 detects whether an unintended large current is supplied to the ejecting module 20 due to an abnormality of the drive current Icom generated based on the drive signal COM supplied to the print head 2. That is, the current threshold Ith2 defined by the threshold information signal Sit2 is a threshold for determining whether the value of the drive current Icom generated based on the drive signal COM is normal. Then, when the value of the drive current Icom is an unintended large current value, the comparator 707 outputs the comparison result signal Icom2 at an H level to the CPU 701.

The CPU 701 determines, based on the logic level of the comparison result signal Icm2 output by the comparator 707, whether an abnormal current is generated in the print head 2. When the CPU 701 determines that the abnormal current is generated in the print head 2, the CPU 701 generates a current detection result signal IDR including information indicating that the abnormal current is generated in the print head 2. Then, the CPU 701 outputs the generated current detection result signal IDR to the control circuit 100. The control circuit 100 stops the operation of the print head 2 according to the input current detection result signal IDR. That is, when the amount of the drive current Icom based on the current detection signal D1 is equal to or larger than the predetermined current threshold Ith2 larger than the current threshold Ith1, the CPU 701 stops the ejection of the ink from the print head 2. Therefore, it is possible to early detect an abnormality in the print head 2.

Furthermore, the CPU 701 can detect, based on the amount of the drive current Icom according to the drive signal COM supplied to the print head 2, whether an unintended leak current is generated in one or more of the piezoelectric elements 60 included in the ejecting module 20, the drive signal selecting circuit 200, or the like.

Specifically, when an unintended leak current is generated in one or more of the piezoelectric elements 60 included in the ejecting module 20, the drive signal selecting circuit 200, or the like, the current threshold Ith2 between the amount of the drive current Icom generated due to the drive signal COM when an unintended leak current is not generated in the piezoelectric elements 60 included in the ejecting module 20, the drive signal selecting circuit 200, and the like and the amount of the drive current Icom generated due to the drive signal COM when an unintended leak current is generated in one or more of the piezoelectric elements 60 included in the ejecting module 20, the drive signal selecting circuit 200, or the like is provided, and the CPU 701 can detect whether an unintended leak current is generated in one or more of the piezoelectric elements 60 included in the ejecting module 20, the drive signal selecting circuit 200, or the like. Therefore, it is possible to further improve the accuracy of detecting an abnormality in the print head 2. In this case, the current threshold Ith2 input to the comparator 707 may be changeable based on the threshold information signal Sith2 output by the control circuit 100.

When the ink is to be ejected by the print head 2, the CPU 701 calculates, as a cumulative drive current T-Icom, a cumulative value of the drive current Icom generated due to the drive signal COM supplied to the print head 2 and causes the calculated cumulative drive current T-Icom to be stored in the storage circuit 704.

Specifically, the CPU 701 reads, as a read signal MR, the cumulative drive current T-Icom stored in the storage circuit 704. Then, the CPU 701 acquires the value of the drive current Icom defined by the current detection signal D1 at least one of a rising edge and a falling edge of the timer signal TC in a time period in which the print head 2 ejects the ink to the medium P, specifically, in a time period for which the comparison result signal Icm1 at an H level is input to the CPU 701. Then, the CPU 701 adds the acquired value of the drive current Icom defined by the current detection signal D1 to the cumulative drive current T-Icom read from the storage circuit 704 and holds the sum of the acquired value of the drive current Icom and the cumulative drive current T-Icom as a new cumulative drive current T-Icom. Thereafter, the CPU 701 generates a storage circuit control signal MC to store, in the storage circuit 704, the cumulative drive current T-Icom held when the image formation period ends. Then, the CPU 701 outputs the generated storage circuit control signal MC to the storage circuit 704. Therefore, the cumulative drive current T-Icom calculated by the CPU 701 is stored in the storage circuit 704. In other words, the storage circuit 704 stores the cumulative value of the drive current Icom.

In addition, the CPU 701 reads, based on the current detection control signal IDS input from the control circuit 100, the cumulative drive current T-Icom stored in the storage circuit 704 as the read signal MR. Then, the CPU 701 estimates the lifetime of the print head 2 and the lifetime of the ejecting module 20 based on the read cumulative drive current T-Icom. In other words, the CPU 701 calculates an estimated lifetime of the ejecting module according to the cumulative drive current T-Icom.

Each of the piezoelectric elements 60 described in the embodiment is a capacitive load having a configuration in which the piezoelectric body 601 is sandwiched between the electrode 611 and the electrode 612, and is deformed by a drive signal VOUT supplied to the electrode 611. The deformed amount of the piezoelectric element 60 that is a capacitive load also depends on the drive current Icom generated due to the drive signal COM. Therefore, the amount of the drive current Icom supplied to the print head 2 is accumulated, the accumulated amount of the drive current Icom is held in the print head 2, and thus it is possible to accurately recognize a degraded state of the print head 2 and a degraded state of each of the piezoelectric elements 60 from amounts of currents supplied to the piezoelectric elements 60 of the ejecting module 20 included in the print head 2. Then, the CPU 701 estimates the lifetime of the ejecting module 20 including the piezoelectric elements 60 based on the degraded states of the piezoelectric elements 60. Therefore, the accuracy of calculating an estimated lifetime of the print head 2 and an estimated lifetime of the ejecting module 20 included in the print head 2 is improved.

Furthermore, since the cumulative drive current T-Icom that is a cumulative value of the drive current Icom supplied to the print head 2 is stored in the storage circuit 704 included in the current detecting circuit 70 included in the print head 2, even when the print head 2 is reused, the CPU 701 can read the cumulative drive current T-Icom stored in the storage circuit 704 and calculate an estimated lifetime of the print head 2 and an estimated lifetime of the ejecting module 20 included in the print head 2 based on the read cumulative drive current T-Icom. Then, it is determined, based on the calculated estimated lifetime, whether the print head 2 is in a state suitable for reuse, and the possibility that a reusable print head 2 may be mistakenly discarded and the possibility that a print head 2 unsuitable for reuse may be mistakenly attached to the liquid ejecting apparatus 1 are reduced. That is, a suitable print head 2 can be reused.

In addition, the CPU 701 calculates, based on the timer signal TC output by the timer circuit 703, a continuous driving period S-Time, a cumulative printing period P-Time, and a cumulative driving period T-Time that indicate the operating state of the print head 2.

The continuous driving period S-Time corresponds to a time period for the print head 2 to continuously eject the ink. The CPU 701 calculates the continuous driving period S-Time by calculating, based on the timer TC output by the timer circuit 703, a time period for the print head 2 to continuously eject the ink.

Specifically, the CPU 701 counts the number of pulses of the timer signal TC input from the timer circuit 703 in a time period for the print head 2 to continuously eject the ink to the medium P, specifically, in a time period for which the comparison result signal Icm1 at an H level is input to the CPU 701. Then, the CPU 701 calculates, from the counted number of pulses of the timer signal TC and a cycle of the pulses of the timer signal TC, a time period for the print head 2 to continuously eject the ink. Thereafter, the CPU 701 resets the calculated continuous driving period S-Time when the comparison result signal Icm1 at an L level is input to the CPU 701. That is, the CPU 701 individually measures, as the continuous driving period S-Time, each of time periods for the print head 2 to continuously eject the ink a plurality of times in the image formation period in which the print head 2 forms an image on the medium P.

The CPU 701 determines whether the measured continuous driving period S-Time is equal to or longer than a predetermined time threshold Tth. Therefore, the CPU 701 determines whether the print head 2 ejects the ink only in the printing region. Specifically, when the continuous driving period S-Time exceeds the predetermined time threshold Tth, the CPU 701 determines that a time period for the print head 2 to continuously eject the ink is long with respect to the moving speed of the print head 2 and the width of the medium P on which the ink lands. That is, when the continuous driving period S-Time exceeds the predetermined time threshold Tth, the CPU 701 determines that the print head 2 ejects the ink in the non-printing region. When the continuous driving period S-Time becomes equal to or longer than the predetermined time threshold Tth, the CPU 701 generates a current detection result signal IDR to stop the ejection of the ink from the print head 2 and outputs the generated current detection result signal IDR to the control circuit 100. The control circuit 100 stops the operation of the print head 2 according to the input current detection result signal IDR.

That is, the CPU 701 calculates, based on the comparison result signal Icm1 output by the comparator 706 and the timer signal TC output by the timer circuit 703, the continuous driving period S-Time for which the ejecting module 20 is continuously driven. When the calculated continuous driving period S-Time is equal to or longer than the predetermined time threshold Tth, the CPU 701 stops the ejection of the ink from the print head 2. Therefore, the possibility that the print head 2 may eject the ink in the non-printing region is reduced. As a result, the possibility that the ink ejected from the print head 2 may adhere to the platen 43 is reduced, and thus the possibility that the medium P transported along the platen 43 may become dirty and damaged is reduced.

In this case, the time threshold Tth to be used for the CPU 701 to determine whether the continuous driving period S-Time is normal may be changeable based on the current detection control signal IDS input to the CPU 701 from the control circuit 100. Specifically, the control circuit 100 sets the time threshold Tth according to image data input to the control circuit 100 from the outside of the liquid ejecting apparatus 1, the size of the medium P on which an image corresponding to the image data is formed, and the moving speed of the print head 2 in the main scan direction. Therefore, the possibility that the print head 2 may eject the ink in the non-printing region regardless of the size of the medium P is reduced. As a result, the possibility that the platen 43 may become dirty and damaged and the possibility that the medium P transported along the platen 43 may become dirty and damaged are reduced.

The cumulative printing period P-Time corresponds to a cumulative value of a time period for the print head 2 to eject the ink to the medium P. The CPU 701 calculates, based on the timer signal TC input in a time period for which the comparison result signal Icm1 at an H level is continuously input, a cumulative value of a time period for the print head 2 to eject the ink to the medium P as the cumulative printing period P-Time. The CPU 701 causes the calculated cumulative printing period P-Time to be stored in the storage circuit 704.

Specifically, the CPU 701 reads the cumulative printing period P-Time stored in the storage circuit 704. Then, the CPU 701 counts the number of pulses of the timer signal TC input from the timer circuit 703 in a time period in which the print head 2 ejects the ink to the medium P, specifically, in a time period for which the comparison result signal Icm1 at an H level is input to the CPU 701. Then, the CPU 701 calculates, from the counted number of pulses of the timer signal TC and the cycle of the pulses of the timer signal TC, a time period in which the print head 2 ejects the ink to the medium P. The CPU 701 adds the calculated time period in which the print head 2 ejects the ink to the medium P to the cumulative printing period P-Time read from the storage circuit 704, and holds the sum of the calculated time period and the cumulative printing period P-Time as a new cumulative printing period P-Time. Thereafter, when the image formation period ends, the CPU 701 generates a storage circuit control signal MC to store the held cumulative printing period P-Time in the storage circuit 704 and outputs the generated storage circuit control signal MC to the storage circuit 704. Therefore, the CPU 701 causes the calculated cumulative printing period P-Time to be stored in the storage circuit 704.

The cumulative printing period P-Time calculated by the CPU 701 is used to calculate an estimated lifetime of the ejecting module 20 based on the cumulative drive current T-Icom described above. Therefore, the CPU 701 can calculate the amount of a current supplied to each of the piezoelectric elements 60 included in the ejecting module 20 per unit time. As a result, it is possible to accurately recognize a degraded state of the print head 2 and a degraded state of the ejecting module 20 included in the print head 2. That is, the accuracy of calculating an estimated lifetime of the print head 2 and an estimated lifetime of the ejecting module 20 included in the print head 2 is improved.

The cumulative driving period T-Time is a time period for the print head 2 to be driven, and corresponds to a cumulative value of the image formation period that includes the movement direction switching period Tr and the main scan direction movement period Tm and in which a desired image is formed on the medium P. The CPU 701 calculates, based on the timer signal TC, a cumulative value of the image formation period in which the print head 2 forms a desired image on the medium P as the cumulative driving period T-Time, and causes the calculated cumulative driving period T-Time to be stored in the storage circuit 704.

Specifically, the CPU 701 reads the cumulative driving period T-Time stored in the storage circuit 704. Then, the CPU 701 counts the number of pulses of the timer signal TC input from the timer circuit 703 in the image formation period in which the print head 2 forms an image on the medium P, and calculates the image formation period from the counted number of pulses of the timer signal TC and the cycle of the pulses of the timer signal TC. Then, the CPU 701 adds the calculated image formation period to the cumulative driving period T-Time read from the storage circuit 704 and holds the sum of the calculated image formation period and the cumulative driving period T-Time as a new cumulative driving period T-Time. Thereafter, the CPU 701 generates a storage circuit control signal MC to store the held cumulative driving period T-Time in the storage circuit 704. Then, the CPU 701 outputs the generated storage circuit control signal MC to the storage circuit 704. As a result, the cumulative driving period T-Time calculated by the CPU 701 is stored in the storage circuit 704.

The cumulative driving period T-Time calculated by the CPU 701 is used to calculate an estimated lifetime of the ejecting module 20 based on the cumulative drive current T-Icom described above. Therefore, the CPU 701 can accurately recognize a degraded state of the ejecting module 20 based on amounts of currents supplied to the piezoelectric elements 60 included in the ejecting module 20 and the total driving period for driving the ejecting module 20. That is, the accuracy of calculating an estimated lifetime of the print head 2 and an estimated lifetime of the ejecting module 20 included in the print head 2 is improved.

In the current detecting circuit 70 configured in the above-described manner, a method of calculating the cumulative drive current T-Icom, the continuous driving period S-Time, the cumulative printing period P-Time, and the cumulative driving period T-Time by the CPU 701 is described in detail with reference to FIG. 11. FIG. 11 is a diagram illustrating an example of a calculation operation of the CPU 701. As illustrated in FIG. 11, when the liquid ejecting apparatus 1 starts a printing process, the CPU 701 initializes the continuous driving period S-Time (step S110). In addition, the CPU 701 reads the cumulative drive current T-Icom, the cumulative printing period P-Time, the cumulative driving period T-Time, the current thresholds Ith1 and Ith2, and the time threshold Tth from the storage circuit 704 (step S120). The CPU 701 may acquire at least one of the current thresholds Ith1 and Ith2 and the time threshold Tth based on the current detection control signal IDS output by the control circuit 100.

Thereafter, the current detector 710 included in the current detecting circuit 70 detects the value of the drive current Icom, generates a current detection signal D1 corresponding to the value of the drive current Icom, and outputs the generated current detection signal D1 to the CPU 701. That is, the CPU 701 acquires the current detection signal D1 corresponding to the value of the drive current Icom and output by the current detector 710 (step S130). Then, the CPU 701 compares the value of the drive current Icom defined by the current detection signal D1 with the current threshold Ith1 (step S140).

When the value of the drive current Icom defined by the current detection signal D1 is larger than the current threshold Ith1 (Y in step S140), the CPU 701 adds the value of the drive current Icom defined by the current detection signal D1 input from the current detector 710 to the value of the cumulative drive current T-Icom read from the storage circuit 704 and holds the sum of the value of the drive current Icom defined by the current detection signal D1 and the value of the cumulative drive current T-Icom as a new cumulative drive current T-Icom (step S150). Then, the CPU 701 adds “1” to the continuous driving period S-Time (step S160) and adds “1” to the cumulative printing period P-Time (step S170). Thereafter, the CPU 701 compares the continuous driving period S-Time with the time threshold Tth (step S190).

On the other hand, when the value of the drive current Icom defined by the current detection signal D1 is equal to or smaller than the current threshold Ith1 (N in step S140), the CPU 701 initializes the continuous driving period S-Time to “0” (step S170). Thereafter, the CPU 701 compares the continuous driving period S-Time with the time threshold Tth (step S190).

When the continuous driving period S-Time is shorter than the time threshold Tth (Y in step S190), the CPU 701 compares the value of the drive current Icom defined by the current detection signal D1 with the current threshold Ith2 (step S200). When the value of the drive current Icom defined by the current detection signal D1 is smaller than the current threshold Ith2 (Y in step S200), the CPU 701 adds “1” to the cumulative driving period T-Time (step S210).

Thereafter, the CPU 701 determines whether the printing process in the liquid ejecting apparatus 1 is already ended (step S220). When the printing process in the liquid ejecting apparatus 1 is not yet ended (N in step S220), the CPU 701 acquires the current detection signal D1 output by the current detector 710 and corresponding to the value of the drive current Icom (step S130) and repeats the same steps as described above.

On the other hand, when the continuous driving period S-Time is equal to or longer than the time threshold Tth (N in step S190) or when the value of the drive current Icom defined by the current detection signal D1 is equal to or larger than the current threshold Ith2 (N in step S200), the CPU 701 generates a current detection result signal IDR indicating an abnormality of the drive current Icom based on the drive signal COM supplied to the print head 2, and outputs the generated current detection result signal IDR to the control circuit 100 (step S230).

After the CPU 701 outputs the current detection result signal IDR indicating the abnormality to the control circuit 100, or when the printing process in the liquid ejecting apparatus 1 is ended (Y in step S220), the CPU 701 causes the held cumulative drive current T-Icom, the held cumulative printing period P-Time, and the held cumulative driving period T-Time to be stored in the storage circuit 704 (step S240), and ends the printing process of the liquid ejecting apparatus 1.

Each of the piezoelectric elements 60 is an example of a drive element. Each of the drive signals VOUT to drive the piezoelectric elements 60 is an example of a drive signal. The drive signal COM is also an example of the drive signal. The CPU 701 is an example of a processor. The current threshold Ith1 is an example of a first threshold. The time threshold Tth is an example of a second threshold. The current threshold Ith2 is an example of a third threshold. The comparator 706 is an example of a first comparator. The comparator 707 is an example of a second comparator. The timer signal TC output by the timer circuit 703 is an example of output from a timer circuit.

### 4. Effects

The print head 2 included in the liquid ejecting apparatus 1 configured in the above-described manner includes the ejecting module 20 including the piezoelectric elements 60 and the nozzles 651 from which the ink is ejected, and the current detecting circuit 70 that detects the drive current Icom generated due to the propagation of the drive signal COM. The current detecting circuit 70 includes the current detector 710 that detects the drive current Icom as the current detection signal D1, and the CPU 701 that controls the operation of the current detecting circuit 70 according to the current detection signal D1. That is, the current detecting circuit 70 included in the print head 2 directly detects the value of the drive current Icom to be supplied to the ejecting module 20.

The amount of the drive current Icom to be supplied to the ejecting module 20 changes according to the operating state of the print head 2. That is, in the print head 2 included in the liquid ejecting apparatus 1 according to the embodiment, the current detector 710 can directly detect the amount of the drive current Icom to be supplied to the ejecting module 20 and thus it is possible to recognize and manage the state of the print head 2 in detail.

The characteristics of the piezoelectric elements 60 included in the ejecting module 20 of the print head 2 are degraded with increases in amounts of currents supplied to the piezoelectric elements 60. In the print head 2 of the liquid ejecting apparatus 1 according to the embodiment, it is possible to directly detect the amount of the drive current Icom to be supplied to the ejecting module 20 and thus it is possible to easily calculate a cumulative value of the amount of a current supplied to each of the piezoelectric elements 60 included in the ejecting module 20. The print head 2 includes the storage circuit 704, and the storage circuit 704 stores a cumulative value of the amount of the drive current Icom supplied to the ejecting module 20. Therefore, the CPU 701 calculates an estimated lifetime of the print head 2 and an estimated lifetime of the ejecting module 20 based on the cumulative value of the amount of the drive current Icom stored in the storage circuit 704, and thus it is possible to improve the accuracy of estimating the lifetime of the print head 2 and the lifetime of the ejecting module 20. That is, in the print head 2 of the liquid ejecting apparatus 2 according to the embodiment, it is possible to recognize and manage the estimated lifetime of the print head 2 as the state of the print head 2 in detail.

The amount of the drive current Icom supplied to the print head 2 in the printing period Tp in which the print head 2 to eject the ink to the medium P is largely different from amounts of the drive current Icom supplied to the print head 2 in the movement direction switching period Tr and the non-printing period To for which the print head 2 does not eject the ink to the medium P. In the print head 2 of the liquid ejecting apparatus 1 according to the embodiment, the current detecting circuit 70 can directly detect the amount of the drive current Icom to be supplied to the ejecting module 20. Therefore, the current detecting circuit 70 includes the comparator 706 that compares the current detection signal D1 with the current threshold Ith1, and the CPU 701 can accurately determine the operating state of the print head 2 and the operating state of the ejecting module 20 by determining the operating state of the ejecting module 20 according to the comparison result signal Icm1 that is the result of the comparison by the comparator 706. That is, in the print head 2 of the liquid ejecting apparatus 1 according to the embodiment, it is possible to recognize and manage the operating state of the print head 2 in detail.

Furthermore, in the print head 2 of the liquid ejecting apparatus 1 according to the embodiment, the current detecting circuit 70 directly detects the amount of the drive current Icom to be supplied to the ejecting module 20 and includes the timer circuit 703, and the CPU 701 can accurately calculate, from the comparison result signal Icm1 indicating the result of the comparison by the comparator 706 and the timer signal TC output by the timer circuit 703, the continuous driving period S-Time for the ejecting module 20 to continuously eject the ink. That is, it is possible to recognize and manage in detail whether the print head 2 is ejecting the ink to the medium P as the operating state of the print head 2. In addition, since the CPU 701 stops the operation of the ejecting module 20 according to whether the calculated continuous driving period S-Time is equal to or longer than the predetermined time threshold Tth, the possibility that the ejecting module 20 may eject the ink outside the range of the medium P is reduced, and the possibility that the ink ejected by the ejecting module 20 may adhere to the platen 43 is reduced. Therefore, the possibility that the medium P supported on the platen 43 may become dirty and damaged is reduced.

In the print head 2 of the liquid ejecting apparatus 1 according to the embodiment, the current detecting circuit 70 directly detects the amount of the drive current Icom to be supplied to the ejecting module 20, and includes the comparator 707 that compares the current detection signal D1 with the current threshold Ith2, the CPU 701 detects whether the print head 2 has an abnormality based on whether the amount of the drive current Icom based on the current detection signal D1 is equal to or larger than the current threshold Ith2, and thus the CPU 701 can accurately determine an abnormal current such as an overcurrent or an unintended leak current that may be generated in one or more of the piezoelectric elements 60, the drive signal selecting circuit 200, or the like included in the print head 2. That is, in the print head 2 of the liquid ejecting apparatus 1 according to the embodiment, it is possible to recognize and manage an abnormal state as the state of the print head 2 in detail.

Although the embodiments and the modifications are described above, the present disclosure is not limited to the embodiments, and the techniques disclosed herein can be implemented in various aspects without departing from the gist of the present disclosure. For example, the embodiments described above can be combined.

The present disclosure includes substantially the same configuration (for example, a configuration with the same functions, methods, and results as described above or a configuration with the same purpose and effects as described above) as the configuration described in the embodiment. In addition, the present disclosure includes a configuration obtained by replacing a part not essential for the configuration described in the embodiment with another part. Furthermore, the present disclosure includes a configuration in which the same effects as those obtained in the configuration described in the embodiment are obtained or the same purpose as that achieved by the configuration described in the embodiment can be achieved. Furthermore, the present disclosure includes a configuration obtained by adding a known technique to the configuration described in the embodiment.

The following content is derived from the embodiment described above.

In an aspect, a print head that includes a drive element to be driven when a drive signal is supplied to the drive element and that ejects liquid by the driving of the drive element includes an ejecting module including the drive element and a nozzle from which the liquid is ejected, and a current detecting circuit that detects a drive current generated due to propagation of the drive signal. The current detecting circuit includes a current detector that detects the drive current as a current detection signal, and a processor that controls an operation of the current detection circuit according to the current detection signal.

According to this print head, the print head includes the ejecting module including the drive element and the nozzle from which the liquid is ejected, and the current detecting circuit that detects the drive current generated due to the propagation of the drive signal. The current detecting circuit includes the current detector that detects the drive current as the current detection signal, and the processor that controls the operation of the current detecting circuit according to the current detection signal. The current detecting circuit can directly detect an amount of a current to be supplied to the ejecting module in the print head. Therefore, it is possible to recognize and manage a state of the print head 2 based on the detected current amount.

In the print head according to the aspect, the current detecting circuit may include a storage circuit that stores a cumulative value of the drive current, and the processor may calculate an estimated lifetime of the ejecting module according to the cumulative value.

According to this print head, it is possible to directly detect an amount of a current to be supplied to the ejecting module and significantly contributing to the lifetime of the ejecting module in the print head, and thus it is possible to improve the accuracy of estimating the lifetime of the print head as the state of the print head 2 based on the detected current amount.

In the print head according to the aspect, the current detecting circuit may include a first comparator that compares the current detection signal with a first threshold, and the processor may determine an operating state of the ejecting module according to a result of the comparison by the first comparator.

According to this print head, it is possible to directly detect an amount of a current that changes depending on an operating state of the print head and is to be supplied to the ejecting module in the print head, and thus it is possible to improve the accuracy of determining the operating state of the print head 2 based on the detected current amount.

In the print head according to the aspect, the first threshold may be changeable.

According to this print head, the optimal first threshold can be used according to a usage state of the print head, and as a result, it is possible to further improve the accuracy of determining the operating state of the print head 2 based on the detected current amount.

In the print head according to the aspect, the current detecting circuit may include a timer circuit, and the processor may calculate, from the result of the comparison and output from the timer circuit, a continuous driving period for continuously driving the ejecting module.

According to this print head, in the print head, it is possible to directly detect the amount of a current that is to be supplied to the ejecting module and changes depending on whether the print head ejects the ink, and thus it is possible to improve the accuracy of detecting, based on the detected current amount, the continuous driving period for the ejecting module to continuously eject the ink as a state of the print head 2.

In the print head according to the aspect, the processor may stop the ejection of the liquid from the nozzle when the continuous driving period is equal to or longer than a predetermined second threshold.

According to this print head, it is possible to reduce the possibility that the print head may eject the ink outside a predetermined region, and the possibility that a transport path through which the medium is transported and the medium may become dirty and damaged is reduced.

In the print head according to the aspect, the second threshold may be changeable.

According to this print head, the optimal second threshold can be used according to a usage state of the print head, and as a result, the possibility that the transport path through which the medium is transported and the medium may become dirty and damaged is reduced.

In the print head according to the aspect, the current detecting circuit may include a second comparator that compares the current detection signal with a third threshold, and the processor may stop the ejection of the liquid from the nozzle when the amount of the drive current based on the current detection signal is equal to or larger than the third threshold.

According to this print head, it is possible to directly detect the amount of the current supplied to the print head and thus it is possible to accurately detect an abnormality in the amount of the current supplied to the print head.

In an aspect, a liquid ejecting apparatus includes a print head that includes a drive element to be driven when a drive signal is supplied to the drive element and that ejects liquid by the driving of the drive element, and a drive circuit that outputs the drive signal. The print head includes an ejecting module including the driving element and a nozzle from which the liquid is ejected, and a current detecting circuit that detects a drive current generated due to propagation of the drive signal. The current detecting circuit includes a current detector that detects the drive current as a current detection signal, and a processor that controls an operation of the current detecting circuit according to the current detection signal.

According to this liquid ejecting apparatus, the print head includes the ejecting module including the drive element and the nozzle from which the liquid is ejected, and the current detecting circuit that detects the drive current generated due to the propagation of the drive signal. The current detecting circuit includes the current detector that detects a drive current as a current detection signal, and the processor that controls an operation of the current detecting circuit according to the current detection signal. Therefore, it is possible to directly detect the amount of the current to be supplied to the ejecting module in the print head and thus it is possible to recognize and manage the state of the print head 2 in detail based on the detected current amount.

What is claimed is:

1. A print head that includes a drive element to be driven when a drive signal is supplied to the drive element and that ejects liquid by the driving of the drive element, the print head comprising:
an ejecting module including the drive element and a nozzle from which the liquid is ejected; and
a current detecting circuit that detects a drive current generated due to propagation of the drive signal, wherein
the current detecting circuit includes
a current detector that detects the drive current as a current detection signal, and
a processor that controls an operation of the current detecting circuit according to the current detection signal.

2. The print head according to claim 1, wherein
the current detecting circuit includes a storage circuit that stores a cumulative value of the drive current, and
the processor calculates an estimated lifetime of the ejecting module according to the cumulative value.

3. The print head according to claim 1, wherein
the current detecting circuit includes a first comparator that compares the current detection signal with a first threshold, and
the processor determines an operating state of the ejecting module according to a result of the comparison by the first comparator.

4. The print head according to claim 3, wherein
the first threshold is changeable.

5. The print head according to claim 3, wherein
the current detecting circuit includes a timer circuit, and
the processor calculates, from the result of the comparison and output from the timer circuit, a continuous driving period for continuously driving the ejecting module.

6. The print head according to claim 5, wherein
the processor stops the ejection of the liquid from the nozzle when the continuous driving period is equal to or longer than a predetermined second threshold.

7. The print head according to claim 6, wherein
the second threshold is changeable.

8. The print head according to claim 1, wherein
the current detecting circuit includes a second comparator that compares the current detection signal with a third threshold, and
the processor stops the ejection of the liquid from the nozzle when an amount of the drive current based on the current detection signal is equal to or larger than the third threshold.

9. A liquid ejecting apparatus comprising:
a print head that includes a drive element to be driven when a drive signal is supplied to the drive element and that ejects liquid by the driving of the drive element; and
a drive circuit that outputs the drive signal, wherein
the print head includes
an ejecting module including the drive element and a nozzle from which the ink is ejected, and
a current detecting circuit that detects a drive current generated due to propagation of the drive signal, and
the current detecting circuit includes
a current detector that detects the drive current as a current detection signal, and
a processor that controls an operation of the current detecting circuit according to the current detection signal.
